(19) United States
(12) Patent Application Publication
(10) Pub. No.: US 2014/0357106 A1
(43) Pub. Date: Dec. 4, 2014

(54) Connector extraction tool

(71) Applicant: MELLANOX TECHNOLOGIES LTD., Yokneam (IL)

(72) Inventors: Gary Varshavsky, Haifa (IL); Dmitriy Volotsky, Kiryat Yam (IL)

(21) Appl. No.: 13/905,149

(22) Filed: May 30, 2013

(51) Int. Cl. H01R 13/633; H01R 43/26

(52) U.S. Cl. CPC H01R 13/633; H01R 43/26
USPC 439/152; 29/825

(57) ABSTRACT

A tool includes an elongated shaft, having an end configured for insertion into a space between adjacent rows of cable connectors held in respective receptacles in a panel. A protrusion projects from the shaft adjacent to the end. The protrusion has a location and height selected so as to engage and compress an elastic retaining latch of a connector that is contained in a receptacle in one of the rows when the end of the shaft is inserted into the space adjacent to the one of the rows, so as to release the connector from the receptacle.

### FIELD OF THE INVENTION

The present invention relates generally to computer and communication systems, and particularly to mechanical accessories for such systems.

### BACKGROUND

Large-scale modern data centers can have hundreds of equipment racks filled with switches, network appliances and computing nodes, connected by thousands of high-speed data cables. These cables are generally connected to receptacles in the front panels of the various items of equipment. The receptacles are typically packed close together in the panel due to considerations of space, cost, and power consumption. At the same time, the receptacles and cable connectors must generally be designed to mate firmly and precisely together, to ensure that data (whether as electrical or optical signals) traverse the connections reliably without interference.

Under these constraints, extracting a cable connector from its panel receptacle can be difficult and is liable to cause damage to the cable if not performed properly. A number of special-purpose tools have therefore been developed to aid in cable extraction. For example, Optimark Fiber Optics (Chestnut Hill, Mass.) offers the Model OPT SF-1 Fiber Optic Connector Insertion/Extraction Tool, which has the form of pliers with “Skinny Fingers” for reaching into spaces between fiberoptic connectors. As another example, FiberFab Inc. (Baltimore, Md.) offers an LC Connector Extraction Tool, which has jaws designed to engage with the latching mechanism of the desired LC connector and remove it in a manner that is said to avoid interference with the adjacent connectors.

### SUMMARY

Embodiments of the present invention provide improved tools and methods for extracting cables from panel connectors.

There is therefore provided, in accordance with an embodiment of the present invention, a tool, including an elongated shaft, having an end configured for insertion into a space between adjacent rows of cable connectors held in respective receptacles in a panel, and a protrusion projecting from the shaft adjacent to the end. The protrusion has a location and height selected so as to engage and compress an elastic retaining latch of a connector that is contained in a receptacle in one of the rows when the end of the shaft is inserted into the space adjacent to the one of the rows, so as to release the connector from the receptacle.

In a disclosed embodiment, the end of the shaft is sharpened so as to facilitate the insertion of the shaft between the adjacent rows, while the shaft is flat, and the protrusion projects from a flat surface of the shaft. In one embodiment, the shaft has a width no greater than 15 mm and a thickness, including the protrusion, that is no greater than 6 mm.

In some embodiments, the cable connectors are contained in adapter modules, which are inserted into the receptacles, wherein the end of the shaft having the protrusion projecting adjacent thereto is a first end, and wherein the tool includes a hook at a second end of the shaft, opposite the first end, configured to engage and remove the adapter modules from the receptacles. Typically, the tool includes a handle, attached to the shaft between the first and second ends and configured to be grasped by a user of the tool.

There is also provided, in accordance with an embodiment of the present invention, a tool, including a flat, elongated shaft having first and second ends, with a protrusion projecting from a surface of the shaft adjacent to the first end and a hook at the second end. A handle is attached to the shaft between the first and second ends.

In a disclosed embodiment, the shaft is configured for insertion into a space between two adjacent rows of cable connectors held in respective receptacles in a panel.

There is additionally provided, in accordance with an embodiment of the present invention, a method for disengaging a cable from a panel. The method includes inserting an end of an elongated shaft of a tool into a space between two adjacent rows of cable connectors held in respective receptacles in the panel. The shaft is advanced within the space so that a protrusion projecting from the shaft adjacent to the end engages and compresses an elastic retaining latch of a connector that is contained in a receptacle in one of the rows and thus releases the connector from the receptacle. The cable is removed from the receptacle by pulling the released connector away from the panel.

In a disclosed embodiment, removing the cable includes releasing the connector from an adapter module, which is contained in the receptacle, and the method includes, after removing the cable from the receptacle, engaging the adapter module using a hook connected to the tool, and pulling the engaged adapter module out of the receptacle using the tool. Typically, the end of the shaft having the protrusion projecting adjacent thereto is a first end, and the hook is located at a second end of the shaft, opposite the first end.

In some embodiments, the cable is an optical cable, and the adapter module includes a small form-factor pluggable (SFP) transceiver module. For example, the connector may be an LC duplex-type connector, while the SFP transceiver module is an SFP+module.

The present invention will be more fully understood from the following detailed description of the embodiments thereof, taken together with the drawings in which:

### BRIEF DESCRIPTION OF THE DRAWINGS

FIG. 1A is a schematic, pictorial illustration of a connector extraction tool, in accordance with an embodiment of the present invention;

FIGS. 1B and 1C are schematic top and side views, respectively, of the connector extraction tool of FIG. 1A;

FIG. 2A is a schematic detail view showing one end of the tool of FIG. 1A;

FIG. 2B is a schematic, cross-sectional view of the end of the tool that is shown in FIG. 2A;

FIG. 3 is a schematic, pictorial illustration showing the use of a tool in extracting a connector from a panel, in accordance with an embodiment of the present invention;

FIGS. 4A-4I are schematic side views showing successive stages in the removal of a connector and an adapter module from a receptacle, in accordance with an embodiment of the present invention;

FIG. 5A is a schematic, pictorial illustration of a connector extraction tool, in accordance with an alternative embodiment of the present invention;

FIG. 5B is a schematic, exploded view of the tool of FIG. 5A; and

FIG. 6 is a schematic, pictorial illustration of a connector extraction tool, in accordance with a further alternative embodiment of the present invention.

### DETAILED DESCRIPTION OF EMBODIMENTS

Existing tools for removal of densely-packed high-speed communication cables from panel receptacles are generally costly and of limited applicability. Furthermore, when receptacles are arranged in a panel in three or more parallel rows, most tools simply cannot reach the connectors in the middle row. Alternative solutions, such as snapping the connectors out of their receptacles with a narrow-bladed screwdriver (commonly used by service personnel, and actually recommended by one manufacturer), run the risk of damaging delicate, costly connection components.

Embodiments of the present invention that are described herein provided improved, dedicated tools for disengaging a cable from the panel of an item of equipment, such as a switch. These tools can be produced at low cost and are easy to use, with minimal risk of damage to connection components. The tool typically comprises an elongated shaft, with an end of appropriate size and shape for insertion into the space between adjacent rows of cable connectors that are held in respective receptacles in a panel. As the end of the shaft is advanced toward a target receptacle, a protrusion projecting outward from the shaft adjacent to the end engages and compresses the elastic retaining latch of the connector that is contained in the receptacle. The latch is thus released, and it is then possible to pull the connector freely away from the panel.

In some applications that are known in the art, cable connectors do not mate directly with the panel receptacles, but rather plug into adapter modules, which themselves are inserted into the receptacles. After removing the cable as described above, it may in some cases be desired to remove the adapter module, as well. For this purpose, in some embodiments of the present invention, the end of the tool opposite the one having the protrusion may comprise a hook, which can be used to engage and remove the adapter module from the receptacle. A handle is typically attached to the shaft (possibly integrally attached, as part of the same unit) midway between the two ends, so that a user grasping the handle can perform both operations—cable removal and adapter module removal—using the same tool.

Reference is now made to FIGS. 1A-1C, which schematically illustrate a connector extraction tool 20, in accordance with an embodiment of the present invention. FIG. 1A is a pictorial view, while FIGS. 1B and 1C are schematic top and side views, respectively. Tool 20 comprises a flat, elongated shaft 21 having two ends. A protrusion 22 projects from one of the flat surfaces of the shaft adjacent to the end. The location and height of the protrusion are selected so as to engage and compress an elastic retaining latch of a connector that is contained in a receptacle, as shown in the figures that follow. This end of shaft 21 may be chamfered to create a sharpened tip 28, in order to facilitate insertion of this end of the shaft between adjacent rows of connectors. The other end of shaft 21 has a hook 24, whose function is likewise shown and described below.

A handle 26, which is grasped by a user of tool 20, is attached to shaft 21 between the two ends. “Attached” in the present sense may mean that the handle is integrally formed with the shaft, and may simply be a part of the shaft that can be easily gripped by the user's fingers. For example, in the embodiment shown in FIGS. 1A-1C, the entire tool may be stamped from a single sheet of metal, such as aluminum. In alternative embodiments, tools for the present purposes may be molded, machined, or formed by any other suitable process.

Typically, the dimensions of tool 20 are small, to permit the tool to be inserted easily and safely between adjacent rows of connectors. In some types of equipment, for example, the connectors in adjacent rows are no more than 4-6 mm apart, while the adapter modules with which the connectors mate are separate by only 1-2 mm. To accommodate this sort of geometry, the width of shaft 21 may be no greater than 15 mm while its thickness, including protrusion 22, is no greater than 6 mm. In one particular embodiment, shaft 21 is about 10 mm wide and less than 4 mm thick, including protrusion 22. The thickness of the shaft itself (not including the protrusion) may be about 2 mm, while tip 28 is chamfered down to about 1 mm.

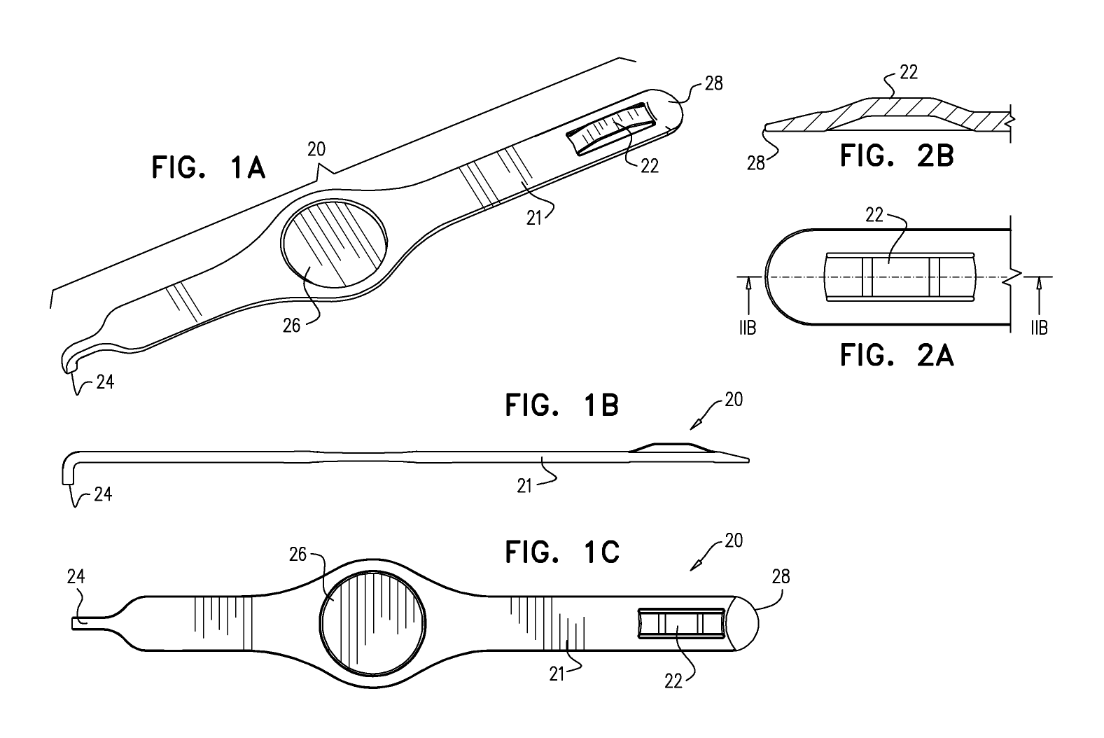

FIGS. 2A and 2B schematically show details of the end of tool 20 that includes protrusion 22. FIG. 2A is a bottom view of the end of the tool, while FIG. 2B is a cross-sectional view taken along the line IIB-IIB in FIG. 2A. To facilitate insertion between adjacent rows of connectors, tip 28 and protrusion 22 have a canted leading edge.

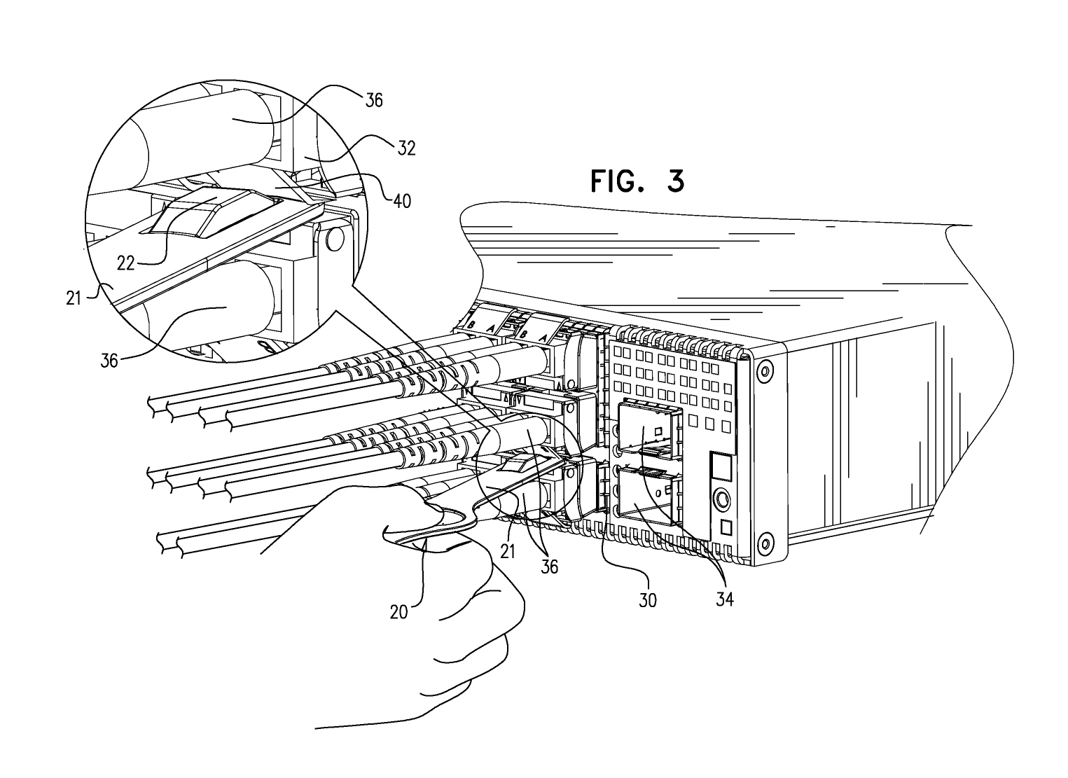

FIG. 3 is a schematic, pictorial illustration showing the use of tool 20 in extracting a connector 36 from a panel 30, in accordance with an embodiment of the present invention. In this particular example, panel 30 contains receptacles 34 that comply with the SFP+ specification in the small form-factor pluggable (SFP) family of standards. Receptacles 34 are arranged in three rows in panel 30. Some of receptacles 34 contain adapter modules 32, which plug into the respective receptacles and have fiberoptic connection sockets for LC duplex-type connectors 36 of optical cables. Each module 32 contains an internal electrical connector that engages a corresponding socket in receptacle 34, as well as transceiver circuitry, which converts between the electrical signals in receptacle 34 and the optical signals transmitted and received by connectors 36. (These internal components of module 32 are not shown in the figures, but they are standard elements, whose ;structure and function are familiar to those skilled in the art.) Tool 20 is designed for use with connectors 36 and modules 32 of this type and is not intended for use, for example, with cables that are integrally connected to an SFP+ module.

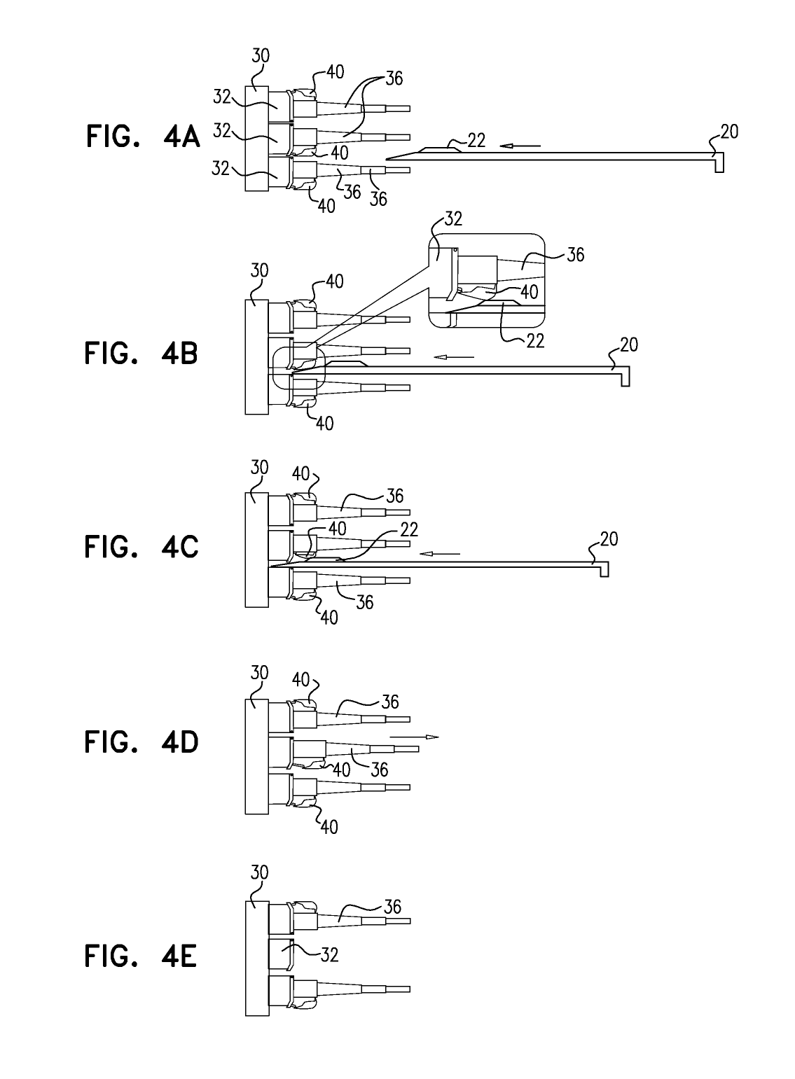

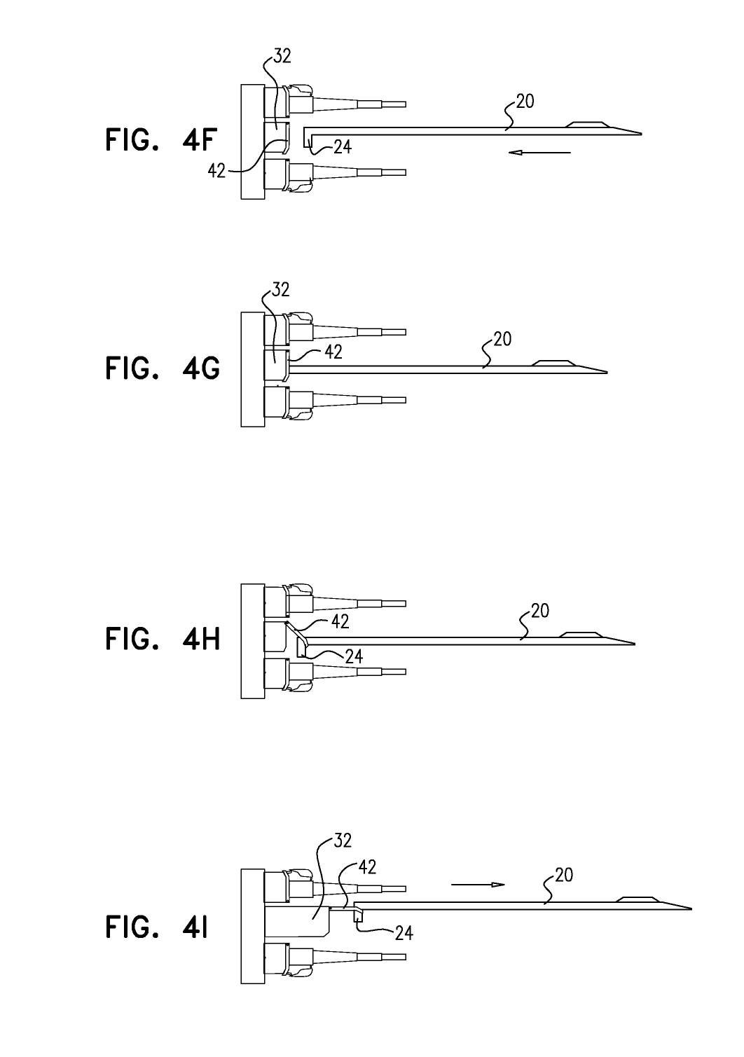

In the pictured embodiment, an operator uses tool 20 in disengaging a connector 36 from the middle row of receptacles 34. Connector 36 is held in place in the socket of adapter module 32 by an elastic retaining latch 40, which snaps into a detent below the socket as the connector is plugged in. To release latch 40, the operator inserts the end of tool 20 into the space below the latch, between the middle and bottom rows of connectors 36, and then proceeds to release the cable as shown in FIGS. 4A-4E and described below. The operator may insert tool 20 either head-on, along a direction roughly parallel to the cable that is to be removed, or at an angle, as shown in FIG. 3. Tool 20 may be used in either of these approaches.

Although FIG. 3 and the figures that follow show particular types of receptacles, adapter modules, and cable connectors by way of example, the principles of the present invention may similarly be applied in providing tools and methods for cable extraction that are appropriate for connectors and receptacles of other types. For example, tool 20 may be adapted for operation with other standards in the SFP family, as well as for other standard cable connectors, including both optical and electronic connectors. Furthermore, such tools may be applied in releasing cable connectors that are plugged directly into panel receptacles, as well as cables that plug in via adapter modules as shown in the figures.

FIGS. 4A-4I are schematic side views showing successive stages in the removal of connector 36 and adapter module 32 from one of receptacles 34 in panel 30, in accordance with an embodiment of the present invention. First, the end of tool 20 is inserted into the space between adjacent rows of connectors 36 (FIG. 4A). The operator advances the shaft of tool 20 within this space so that protrusion 22, adjacent to the end of the shaft, engages latch 40 of connector 36 (FIG. 4B) and then compresses the latch against the connector (FIG. 4C). As a result latch 40 is freed from the detent of the plug in adapter module 32, and connector 36 is thus released (FIG. 4D). The operator can then remove the cable from adapter module 32 and receptacle 34 by pulling the released connector 36 away from panel 30 (FIG. 4E).

At this stage, the operator may, if desired, remove adapter module 32 from receptacle 34 (to replace it with a different sort of adapter or transceiver module, for example). For this purpose, the operator uses hook 24, at the opposite end of tool 20, to engage module 32 (FIG. 4F). In this specific example, hook 24 engages a hinged pull handle 42, which is provided as a part of module 32 for this purpose (FIG. 4G). (Alternatively, hook 24 may be used to engage pull handles and implements of other types, or even to engage the shell of module 32 directly.) The operator now pulls tool 20 outward, so that handle 42 turns outward (4H). The operator continues pulling until adapter module 32 slides out of receptacle 34 and away from panel 30 (FIG. 41).

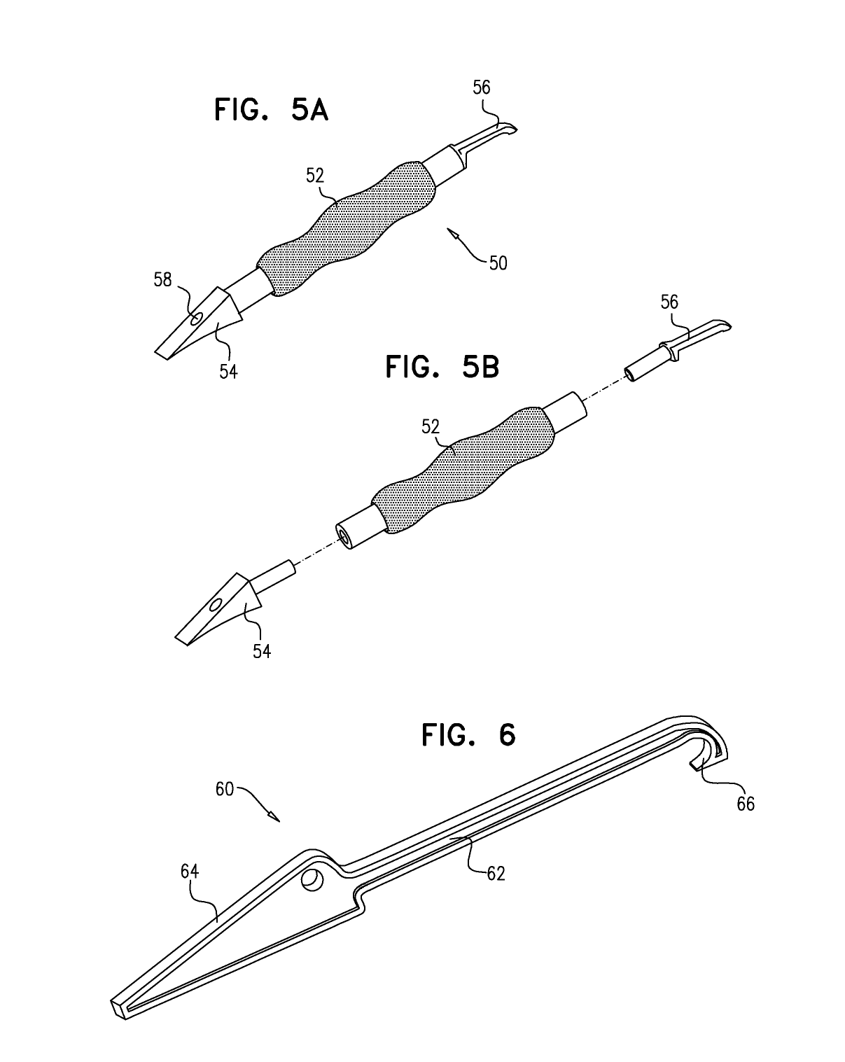

FIGS. 5A and 5B schematically illustrate a connector extraction tool 50, in accordance with an alternative embodiment of the present invention. FIG. 5A is a pictorial illustration, while FIG. 5B is an exploded view of tool 50. Tool 50 comprises a handle 52, to which two end pieces 54 and 56 are attached. End piece 54 comprises a shaft with a protrusion suitable for releasing the elastic latch of a cable connector, as described above, while end piece 56 has a hook. End piece 54 may optionally contain a miniature lamp, such as an LED, to assist the operator by illuminating the work area. The design of tool 50 is advantageous in that it allows the end pieces to be adjusted and/or replaced as necessary to deal with different panel geometries and connector types.

FIG. 6 is a schematic, pictorial illustration of a connector extraction tool 60, in accordance with a further alternative embodiment of the present invention. Tool 60, as in the preceding embodiments, comprises a shaft 62, with end 64 having a protrusion for unlatching a cable connector, and end 66 having a hook. The design of tool 60 is suitable for plastic injection molding and thus offers particularly low manufacturing cost.

Although certain particular tool designs have been shown and described above by way of illustration, other designs implementing similar principles will be apparent to those skilled in the art after reading the above description and are considered to be within the scope of the present invention. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A tool, comprising:
an elongated shaft, having an end configured for insertion into a space between adjacent rows of cable connectors held in respective receptacles in a panel; and
a protrusion projecting from the shaft adjacent to the end, the protrusion having a location and height selected so as to engage and compress an elastic retaining latch of a connector that is contained in a receptacle in one of the rows when the end of the shaft is inserted into the space adjacent to the one of the rows, so as to release the connector from the receptacle.

2. The tool according to claim 1, wherein the end of the shaft is sharpened so as to facilitate the insertion of the shaft between the adjacent rows.

3. The tool according to claim 2, wherein the shaft is flat, and wherein the protrusion projects from a flat surface of the shaft.

4. The tool according to claim 3, wherein the shaft has a width no greater than 15 mm and a thickness, including the protrusion, that is no greater than 6 mm.

5. The tool according to claim 1, wherein the cable connectors are contained in adapter modules, which are inserted into the receptacles, wherein the end of the shaft having the protrusion projecting adjacent thereto is a first end, and wherein the tool comprises a hook at a second end of the shaft, opposite the first end, configured to engage and remove the adapter modules from the receptacles.

6. The tool according to claim 5, and comprising a handle, attached to the shaft between the first and second ends and configured to be grasped by a user of the tool.

7. A tool, comprising:
a flat, elongated shaft having first and second ends, with a protrusion projecting from a surface of the shaft adjacent to the first end and a hook at the second end; and
a handle attached to the shaft between the first and second ends.

8. The tool according to claim 7, wherein the shaft is configured for insertion into a space between two adjacent rows of cable connectors held in respective receptacles in a panel.

9. A method for disengaging a cable from a panel, the method comprising:
inserting an end of an elongated shaft of a tool into a space between two adjacent rows of cable connectors held in respective receptacles in the panel;
advancing the shaft within the space so that a protrusion projecting from the shaft adjacent to the end engages and compresses an elastic retaining latch of a connector that is contained in a receptacle in one of the rows and thus releases the connector from the receptacle; and
removing the cable from the receptacle by pulling the released connector away from the panel.

10. The method according to claim 9, wherein removing the cable comprises releasing the connector from an adapter module, which is contained in the receptacle, and wherein the method comprises, after removing the cable from the receptacle, engaging the adapter module using a hook connected to the tool, and pulling the engaged adapter module out of the receptacle using the tool.

11. The method according to claim 10, wherein the end of the shaft having the protrusion projecting adjacent thereto is a first end, and wherein the hook is located at a second end of the shaft, opposite the first end.

12. The method according to claim 10, wherein the cable is an optical cable, and wherein the adapter module comprises a small form-factor pluggable (SFP) transceiver module.

13. The method according to claim 12, wherein the connector is an LC duplex-type connector, and the SFP transceiver module is an SFP+ module.
